(19) United States
(12) Patent Application Publication
(10) Pub. No.: US 2023/0413177 A1
(43) Pub. Date: Dec. 21, 2023

(54) UE NON-SSB RSS RECEPTION IN IDLE FOR POWER SAVING

(71) Applicant: Telefonaktiebolaget LM Ericsson (publ), Stockholm (SE)

(72) Inventors: Gang ZOU, Lund (SE); Sina MALEKI, Malmö (SE); Andres REIAL, Höllviken (SE)

(21) Appl. No.: 18/032,270

(22) PCT Filed: Oct. 19, 2021
(86) PCT No.: PCT/EP2021/078999

§ 371 Date: Apr. 17, 2023

Related U.S. Application Data
(60) Provisional application No. 63/104,996, filed on Oct. 23, 2020.

(51) Int. Cl. H04W 52/02; H04L 5/00

(52) U.S. Cl. CPC H04W 52/0229; H04L 5/0048

(57) ABSTRACT

A method, system and apparatus are disclosed. According to one or more embodiments, a wireless device (WD) configured to communicate with a network node is provided. The WD is configured to, and/or includes a radio interface and/or processing circuitry configured to modify at least one wireless device configuration for at least one of receiving and processing at least a non-synchronization signal block (SSB) reference signal while in idle mode.

### FIELD

The present disclosure relates to wireless communications and reference signals outside a synchronization signal block, SSB, and in particular, to an idle mode wireless device receiving and processing a non-SSB reference signal and a method for receiving and processing a non-SSB reference signal.

### INTRODUCTION

The Third Generation Partnership Project (3GPP) is defining technical specifications (TSs) for New Radio (NR, also referred to as 5^{th} Generation (5G)). In 3GPP Release 15 (Rel-15) NR, a user equipment (UE, also referred to as a wireless device) can be configured with up to four carrier bandwidth parts (BWPs) in the downlink with a single downlink carrier bandwidth part being active at a given time. A wireless device can be configured with up to four carrier bandwidth parts in the uplink with a single uplink carrier bandwidth part being active at a given time. If a wireless device is configured with a supplementary uplink, the wireless device can additionally be configured with up to four carrier bandwidth parts in the supplementary uplink with a single supplementary uplink carrier bandwidth part being active at a given time.

For a carrier bandwidth part with a given numerology μᵢ, a contiguous set of physical resource blocks (PRBs) are defined and numbered from 0 to N^{size}_{BWB}−1where i is the index of the carrier bandwidth part. A resource block (RB) is defined as 12 consecutive subcarriers in the frequency domain.

Multiple orthogonal frequency-division multiplexing (OFDM) numerologies, μ, are supported in NR as illustrated in Table 1 below, where the subcarrier spacing, Δf, and the cyclic prefix for a carrier bandwidth part are configured by different higher layer parameters for downlink (DL) and uplink (UL), respectively.

TABLE 1
Supported Transmission Numerologies

| μ | Δf = 2^{μ} · 15 [kHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |

### Physical Channels

A downlink physical channel corresponds to a set of resource elements carrying information originating from higher layers. The following example downlink physical channels are defined:

Physical Downlink Shared Channel, PDSCH

Physical Broadcast Channel, PBCH

Physical Downlink Control Channel, PDCCH

PDSCH is a physical channel used for unicast downlink data transmission, but also for transmission of RAR (random access response), certain system information blocks, and paging information. Physical broadcast channel (PBCH) carries the basic system information, required by the wireless device to access the network node. Physical downlink control channel (PDCCH) is used for transmitting downlink control information (DCI), mainly scheduling decisions, required for reception of PDSCH, and for uplink scheduling grants enabling transmission on physical uplink shared channel (PUSCH).

An uplink physical channel corresponds to a set of resource elements carrying information originating from higher layers. The following example uplink physical channels are defined:

Physical Uplink Shared Channel, PUSCH:

Physical Uplink Control Channel, PUCCH

Physical Random Access Channel, PRACH

PUSCH is the uplink counterpart to the PDSCH. PUCCH is used by wireless devices to transmit uplink control information, including hybrid automatic repeat request (HARQ) acknowledgements, channel state information reports, etc. Physical random access channel (PRACH) is used for random access preamble transmission.

### NR Reference Symbols

The ultra-lean design principle in NR aims to minimize the always-on transmissions that exists in earlier systems (e.g., Long Term Evolution (LTE) cell specific reference signal (CRS) reference symbols). Instead, NR provides reference symbols such as synchronization signal SS blocks (SSBs) on a periodic basis, by default once every 20 ms. In addition, for connected mode wireless devices, typically a set of reference symbols are provided for optimal link performance. Some of these reference symbols are clarified below.

### Channel State Information (CSI)-Reference Signal (RS) for Tracking

A wireless device in radio resource control (RRC) connected mode is expected to receive from the network node the RRC layer wireless device specific configuration of a NZP-CSI-RS-ResourceSet configured including the parameter trs-Info. For a NZP-CSI-RS-ResourceSet configured with the higher layer parameter trs-Info set to “true”, the wireless device assumes the antenna port with the same port index of the configured NZP CSI-RS resources in the NZP-CSI-RS-ResourceSet is the same.

For frequency range 1 (FR1), the wireless device may be configured with one or more NZP CSI-RS set(s), where a NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon or tdd-UL-DL-ConfigDedicated, then the wireless device may be configured with one or more NZP CSI-RS set(s), where a NZP-CSI-RS-ResourceSet consists of two periodic NZP CSI-RS resources in one slot.

For frequency range 2 (FR2), the wireless device may be configured with one or more NZP CSI-RS set(s), where a NZP-CSI-RS-ResourceSet consists of two periodic CSI-RS resources in one slot or with a NZP-CSI-RS-ResourceSet of four periodic NZP CSI-RS resources in two consecutive slots with two periodic NZP CSI-RS resources in each slot.

A wireless device configured with NZP-CSI-RS-ResourceSet(s) configured with higher layer parameter trs-Info may have the CSI-RS resources configured as:

Periodic, with the CSI-RS resources in the NZP-CSI-RS-ResourceSet configured with same periodicity, bandwidth and subcarrier location.

Periodic CSI-RS resource in one set and aperiodic CSI-RS resources in a second set, with the aperiodic CSI-RS and periodic CSI-RS resource having the same bandwidth (with same RB location) and the aperiodic CSI-RS being ‘QCL-Type-A’ and ‘QCL-TypeD’, where applicable, with the periodic CSI-RS resources. For frequency range 2, the wireless device does not expect that the scheduling offset between the last symbol of the PDCCH carrying the triggering DCI and the first symbol of the aperiodic CSI-RS resources is smaller than the wireless device reported ThresholdSched-Offset. The wireless device expects that the periodic CSI-RS resource set and aperiodic CSI-RS resource set are configured with the same number of CSI-RS resources and with the same number of CSI-RS resources in a slot. For the aperiodic CSI-RS resource set if triggered, and if the associated periodic CSI-RS resource set is configured with four periodic CSI-RS resources with two consecutive slots with two periodic CSI-RS resources in each slot, the higher layer parameter aperiodicTriggeringOffset indicates the triggering offset for the first slot for the first two CSI-RS resources in the set.

A wireless device does not expect to be configured with a CSI-ReportConfig that is linked to a CSI-ResourceConfig containing an NZP-CSI-RS-ResourceSet configured with trs-Info and with the CSI-ReportConfig configured with the higher layer parameter timeRestrictionForChannelMeasurements set to “configured.”

A wireless device does not expect to be configured with a CSI-ReportConfig with the higher layer parameter reportQuantity set to other than “none” for aperiodic NZP CSI-RS resource set configured with trs-Info.

A wireless device does not expect to be configured with a CSI-ReportConfig for periodic NZP CSI-RS resource set configured with trs-Info.

A wireless device does not expect to be configured with a NZP-CSI-RS-ResourceSet configured both with trs-Info and repetition.

Each CSI-RS resource, defined in 3GPP specification(s) such as in Clause 7.4.1.5.3 of 3GPP TS 38.211, is configured by the higher layer parameter NZP-CSI-RS-Resource with the following restrictions:

the time-domain locations of the two CSI-RS resources in a slot, or of the four CSI-RS resources in two consecutive slots (which are the same across two consecutive slots), as defined by higher layer parameter CSI-RS-resourceMapping, is given by one of:

l∈{4,8}, l∈{5,9}, or l∈{6,10} for frequency range 1 and frequency range 2,
l∈{0,4}, l∈{1,5}, l∈{2,6}, l∈{3,7}, l∈{7,11}, l∈{8,12}for frequency range 2.

a single port CSI-RS resource with density ρ=3 given in 3GPP specification(s) such as in Table 7.4.1.5.3-1 from 3GPP TS 38.211 and higher layer parameter density configured by CSI-RS-ResourceMapping.

the bandwidth of the CSI-RS resource, as given by the higher layer parameter freqBand configured by CSI-RS-ResourceMapping, is the minimum of 52 and N_{BWP,i}^{size} resource blocks, or is equal to N_{BWP,i}^{size} resource blocks. For operation with shared spectrum channel access, freqBand configured by CSI-RS-ResourceMapping, is the minimum of 48 and N_{BWP,i}^{size} resource blocks, or is equal to N_{BWP,i}^{size} resource blocks.

the wireless device is not expected to be configured with the periodicity of 2^{μ}×10 slots if the bandwidth of CSI-RS resource is larger than 52 resource blocks.

the periodicity and slot offset for periodic NZP CSI-RS resources, as given by the higher layer parameter periodicityAndOffset configured by NZP-CSI-RS-Resource, is one of ^{μ}Xₚ slots where Xₚ=10, 20, 40, or 80 and where μ is defined in 3GPP specification(s) such as in Clause 4.3 of 3GPP TS 38.211.

same powerControlOffset and powerControlOffsetSS given by NZP-CSI-RS-Resource value across all resources.

### NZP CSI-RS

The wireless device can be configured with one or more NZP CSI-RS resource set configuration(s) as indicated by the higher layer parameters CSI-ResourceConfig, and NZP-CSI-RS-ResourceSet. Each NZP CSI-RS resource set consists of K≥1 NZP CSI-RS resource(s).

The following parameters for which the wireless device assumes non-zero transmission power for CSI-RS resource are configured via the higher layer parameter NZP-CSI-RS-Resource, CSI-ResourceConfig and NZP-CSI-RS-ResourceSet for each CSI-RS resource configuration:

nzp-CSI-RS-ResourceId determines CSI-RS resource configuration identity.

periodicityAndOffset defines the CSI-RS periodicity and slot offset for periodic/semi-persistent CSI-RS. All the CSI-RS resources within one set are configured with the same periodicity, while the slot offset can be same or different for different CSI-RS resources.

resourceMapping defines the number of ports, CDM-type, and OFDM symbol and subcarrier occupancy of the CSI-RS resource within a slot that are given in 3GPP specification such as in Clause 7.4.1.5 of 3GPP TS 38.211.

nrofPorts in resourceMapping defines the number of CSI-RS ports, where the allowable values are given in 3GPP specification such as in Clause 7.4.1.5 of 3GPP TS 38.211.

density in resourceMapping defines CSI-RS frequency density of each CSI-RS port per PRB, and CSI-RS PRB offset in case of the density value of 1/2, where the allowable values are given in 3GPP specification such as in Clause 7.4.1.5 of 3GPP TS 38.211. For density 1/2, the odd/even PRB allocation indicated in density is with respect to the common resource block grid.

cdm-Type in resourceMapping defines CDM values and pattern, where the allowable values are given in 3GPP specification such as in Clause 7.4.1.5 of 3GPP TS 38.211.

powerControlOffset: which is the assumed ratio of PDSCH EPRE to NZP CSI-RS EPRE when the wireless device derives CSI feedback and takes values in the range of [−8, 15] dB with 1 dB step size.

powerControlOffsetSS: which is the assumed ratio of NZP CSI-RS EPRE to SS/PBCH block EPRE. scramblingID defines scrambling ID of CSI-RS with length of 10 bits.

BWP-Id in CSI-ResourceConfig defines which bandwidth part the configured CSI-RS is located in.

repetition in NZP-CSI-RS-ResourceSet is associated with a CSI-RS resource set and defines whether the wireless device can assume the CSI-RS resources within the NZP CSI-RS Resource Set are transmitted with the same downlink spatial domain transmission filter or not as described in 3GPP specification such as in, for example, 3GPP TS 38.211, of for example, Clause 5.1.6.1.2., and can be configured only when the higher layer parameter reportQuantity associated with all the reporting settings linked with the CSI-RS resource set is set to ‘cri-RSRP’, ‘cri-SINR’ or ‘none’.

qcl-InfoPeriodicCSI-RS contains a reference to a TCI-State indicating QCL source RS(s) and QCL type(s). If the TCI-State is configured with a reference to an RS with ‘QCL-TypeD’ association, that RS may be an SS/PBCH block located in the same or different CC/DL BWP or a CSI-RS resource configured as periodic located in the same or different CC/DL BWP.

trs-Info in NZP-CSI-RS-ResourceSet is associated with a CSI-RS resource set and for which the wireless device can assume that the antenna port with the same port index of the configured NZP CSI-RS resources in the NZP-CSI-RS-ResourceSet is the same as described in 3GPP specification such as in, for example, 3GPP TS 38.211, of, for example, Clause 5.1.6.1.1 and can be configured when reporting setting is not configured or when the higher layer parameter reportQuantity associated with all the reporting settings linked with the CSI-RS resource set is set to “none.”

All CSI-RS resources within one set are configured with same density and same nrofPorts, except for the NZP CSI-RS resources used for interference measurement.

The wireless device expects that all the CSI-RS resources of a resource set are configured with the same starting RB and number of RBs and the same cdm-type.

The bandwidth and initial common resource block (CRB) index of a CSI-RS resource within a BWP, as defined in 3GPP specification such as in Clause 7.4.1.5 of 3GPP TS 38.211, are determined based on the higher layer parameters nrofRBs and startingRB, respectively, within the CSI-FrequencyOccupation IE configured by the higher layer parameter freqBand within the CSI-RS-ResourceMapping IE. Both nrofRBs and startingRB are configured as integer multiples of 4 RBs, and the reference point for startingRB is CRB 0 on the common resource block grid. If starting RB<N_{BWP}^{start}, the wireless device assume that the initial CRB index of the CSI-RS resource is N_{initial RB}=N_{BWP}^{start}, otherwise N_{initial RB}=startingRB. If nrof RBs>N_{BWP}^{size}+N_{BWP}^{start}−N_{initial RB}, the wireless device assumes that the bandwidth of the CSI-RS resource is N_{CSI-RS}^{BW}=N_{BWP}^{size}+N_{BWP}^{start}−N_{initial RB}, otherwise N_{CSI-RS}^{BW}=nrofRBs. In all cases, the wireless device expects that N_{CSI-RS}^{BW}≥min (24, N_{BWP}^{size}).

### NZP-CSI-RS-Resource

The IE NZP-CSI-RS-Resource is used to configure Non-Zero-Power (NZP) CSI-RS transmitted in the cell where the IE is included, which the wireless device may be configured to measure on as may be described in 3GPP TS 38.214, clause 5.2.2.3.1.

NZP-CSI-RS-Resource information element

ASN1START
TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED {db−3, db0, db3, db6} |

OPTIONAL, -- Need R

| scramblingID | ScramblingId, | |
|---|---|---|
| periodicityAndOffset | CSI-ResourcePeriodicityAndOffset | OPTIONAL, -- |

Cond PeriodicOrSemiPersistent

| | | |
|---|---|---|
| qcl-InfoPeriodicCSI-RS | TCI-StateId | OPTIONAL, -- Cond |

Periodic

```
  ...
  }
```

TAG-NZP-CSI-RS-RESOURCE-STOP
ASN1STOP

NZP-CSI-RS-Resource field descriptions
periodicityAndOffset
Periodicity and slot offset sl1 corresponds to a periodicity of 1 slot, sl2 to a periodicity of two
slots, and so on. The corresponding offset is also given in number of slots as described in 3GPP
specification such as in 3GPP TS 38.214, clause 5.2.2.3.1)
powerControlOffset
Power offset of PDSCH RE to NZP CSI-RS RE. Value in dB as described in 3GPP specification
such as in 3GPP TS 38.214, clauses 5.2.2.3.1 and 4.1
powerControlOffsetSS
Power offset of NZP CSI-RS RE to SS RE. Value in dB as described in 3GPP specification such
as in 3GPP TS 38.214, clause 5.2.2.3.1
qcl-InfoPeriodicCSI-RS
For a target periodic CSI-RS, contains a reference to one TCI-State in TCI-States for providing
the QCL source and QCL type. For periodic CSI-RS, the source can be SSB or another periodic-
CSI-RS. Refers to the TCI-State which has this value for tci-StateId and is defined in tci-
StatesToAddModList in the PDSCH-Config included in the BWP-Downlink corresponding to the
serving cell and to the DL BWP to which the resource belongs to 3GPP specification such as in
3GPP TS 38.214, clause 5.2.2.3.1
resourceMapping
OFDM symbol location(s) in a slot and subcarrier occupancy in a PRB of the CSI-RS resource
scramblingID
Scrambling ID as described in 3GPP specification such as in 3GPP TS 38.214, clause 5.2.2.3.1

| Conditional Presence | Explanation |
|---|---|
| Periodic | The field is optionally present, Need M, for |
| | periodic NZP-CSI-RS-Resources (as indicated |
| | in CSI-ResourceConfig). The field is absent |
| | otherwise |
| PeriodicOrSemiPersistent | The field is mandatory present, Need M, for |
| | periodic and semi-persistent NZP-CSI-RS- |
| | Resources (as indicated in CSI-ResourceConfig). |
| | The field is absent otherwise. |

### NZP-CSI-RS-ResourceId

The IE NZP-CSI-RS-ResourceId is used to identify one NZP-CSI-RS-Resource.

NZP-CSI-RS-ResourceId information element

ASN1START
TAG-NZP-CSI-RS-RESOURCEID-START

| | |
|---|---|
| NZP-CSI-RS-ResourceId ::= | INTEGER (0..maxNrofNZP-CSI-RS-Resources−1) |

TAG-NZP-CSI-RS-RESOURCEID-STOP
ASN1STOP

NZP-CSI-RS-ResourceSet
The IE NZP-CSI-RS-ResourceSet is a set of Non-Zero-Power (NZP) CSI-RS resources (their IDs)
and set-specific parameters.
NZP-CSI-RS-ResourceSet information element

ASN1START
TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-ResourcesPerSet)) |

OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R

...
}

TAG-NZP-CSI-RS-RESOURCESET-STOP
ASN1STOP

NZP-CSI-RS-ResourceSet field descriptions
aperiodicTriggeringOffset
Offset X between the slot containing the DCI that triggers a set of aperiodic NZP CSI-RS
resources and the slot in which the CSI-RS resource set is transmitted. The value 0 corresponds
to 0 slots, value 1 corresponds to 1 slot, value 2 corresponds to 2 slots, value 3 corresponds to 3
slots, value 4 corresponds to 4 slots, value 5 corresponds to 16 slots, value 6 corresponds to 24
slots. When the field is absent the wireless device applies the value 0.
nzp-CSI-RS-Resources
NZP-CSI-RS-Resources associated with this NZP-CSI-RS resource set as described in 3GPP
specification such as in 3GPP TS 38.214, clause 5.2. For CSI, there are at most 8 NZP CSI RS
resources per resource set
repetition
Indicates whether repetition is on/off. If the field is set to ′OFF′ or if the field is absent, the
wireless device may not assume that the NZP-CSI-RS resources within the resource set are
transmitted with the same downlink spatial domain transmission filter and with same NrofPorts
in every symbol as described in 3GPP specification such as 3GPP TS 38.214, clauses 5.2.2.3.1
and 5.1.6.1.2. Can only be configured for CSI-RS resource sets which are associated with CSI-
ReportConfig with report of L1 RSRP or “no report”
trs-Info
Indicates that the antenna port for all NZP-CSI-RS resources in the CSI-RS resource set is same.
If the field is absent or released the wireless device applies the value “false” as described in
3GPP specification such as in 3GPP TS 38.214, clause 5.2.2.3.1.

### NZP-CSI-RS-ResourceSetId

The IE NZP-CSI-RS-ResourceSetId is used to identify one NZP-CSI-RS-ResourceSet.

```
NZP-CSI-RS-ResourceSetId information element
            ASN1START
            TAG-NZP-CSI-RS-RESOURCESETID-START
NZP-CSI-RS-ResourceSetId ::= INTEGER (0..maxNrofNZP-CSI-RS-ResourceSets−1)
            TAG-NZP-CSI-RS-RESOURCESETID-STOP
            ASN1STOP
```

### CSI-ResourceConfig

The IE CSI-ResourceConfig defines a group of one or more NZP-CSI-RS-ResourceSet, CSI-IM-ResourceSet and/or CSI-SSB-ResourceSet.

```
CSI-ResourceConfig information element
            ASN1START
            TAG-CSI-RESOURCECONFIG-START
CSI-ResourceConfig ::= SEQUENCE {
csi-ResourceConfigId CSI-ResourceConfigId,
csi-RS-ResourceSetList CHOICE {
nzp-CSI-RS-SSB SEQUENCE {
    nzp-CSI-RS-ResourceSetList SEQUENCE (SIZE (1..maxNrofNZP-CSI-RS-
    ResourceSetsPerConfig)) OF NZP-CSI-RS-ResourceSetId
                                              OPTIONAL, -- Need R
    csi-SSB-ResourceSetList SEQUENCE (SIZE (1..maxNrofCSI-SSB-
    ResourceSetsPerConfig)) OF CSI-SSB-ResourceSetId
                                              OPTIONAL -- Need R
},
csi-IM-ResourceSetList SEQUENCE (SIZE (1..maxNrofCSI-IM-ResourceSetsPerConfig)) OF
CSI-IM-ResourceSetId
},
bwp-Id BWP-Id,
resourceType ENUMERATED { aperiodic, semiPersistent, periodic },
...
}
            TAG-CSI-RESOURCECONFIG-STOP
            ASN1STOP
```

CSI-ResourceConfig field descriptions
bwp-Id
The DL BWP which the CSI-RS associated with this CSI-ResourceConfig are located in 3GPP
specification such as in3GPP TS 38.214, clause 5.2.1.2
csi-ResourceConfigId
Used in CSI-ReportConfig to refer to an instance of CSI-ResourceConfig
csi-RS-ResourceSetList
Contains up to maxNrofNZP-CSI-RS-ResourceSetsPerConfig resource sets if
ResourceConfigType is ‘aperiodic’ and 1 otherwise as described in 3GPP Specification such as
in 3GPP TS 38.214, clause 5.2.1.2)
csi-SSB-ResourceSetList
List of SSB resources used for beam measurement and reporting in a resource set as described in
3GPP Specification such as in 3GPP TS 38.214, section FFS_Section.
resourceType
Time domain behavior of resource configuration as described in 3GPP Specification such as in
3GPP TS 38.214, clause 5.2.1.2. It does not apply to resources provided in the csi-SSB-
ResourceSetList.

### CSI-ResourceConfigId

The IE CSI-ResourceConfigId is used to identify a CSI-ResourceConfig.

```
CSI-ResourceConfigId information element
            ASN1START
            TAG-CSI-RESOURCECONFIGID-START
CSI-ResourceConfigId ::= INTEGER (0..maxNrofCSI-ResourceConfigurations−1)
            TAG-CSI-RESOURCECONFIGID-STOP
            ASN1STOP
```

### CSI-ResourcePeriodicityAndOffset

The IE CSI-ResourcePeriodicityAndOffset is used to configure a periodicity and a corresponding offset for periodic and semi-persistent CSI resources, and for periodic and semi-persistent reporting on PUCCH. both, the periodicity and the offset are given in number of slots. The periodicity value slots4 corresponds to 4 slots, slots5 corresponds to 5 slots, and so on.

```
CSI-ResourcePeriodicityAndOffset information element
            ASN1START
            TAG-CSI-RESOURCEPERIODICITYANDOFFSET-START
CSI-ResourcePeriodicityAndOffset ::= CHOICE {
slots4 INTEGER (0..3),
slots5 INTEGER (0..4),
slots8 INTEGER (0..7),
slots10 INTEGER (0..9),
slots16 INTEGER (0..15),
slots20 INTEGER (0..19),
slots32 INTEGER (0..31),
slots40 INTEGER (0..39),
slots64 INTEGER (0..63),
slots80 INTEGER (0..79),
slots160 INTEGER (0..159),
slots320 INTEGER (0..319),
slots640 INTEGER (0..639)
}
            TAG-CSI-RESOURCEPERIODICITYANDOFFSET-STOP
            ASN1STOP
```

### CSI-RS-ResourceConfigMobility

The IE CSI-RS-ResourceConfigMobility is used to configure CSI-RS based RRM measurements.

```
CSI-RS-ReSourceConfigMobility information element
            ASN1START
            TAG-CSI-RS-RESOURCECONFIGMOBILITY-START
CSI-RS-ReSourceConfigMobility ::= SEQUENCE {
```

| | |
|---|---|
| subcarrierSpacing | SubcarrierSpacing, |
| csi-RS-CellList-Mobility | SEQUENCE (SIZE (1..maxNrofCSI-RS-CellsRRM)) OF CSI- |

RS-CellMobility,

... ,
[[

| | | |
|---|---|---|
| refServCellIndex-v1530 | ServCellIndex | OPTIONAL |

-- Need S

| ]] | | |
|---|---|---|
| } | | |
| CSI-RS-CellMobility ::= | | SEQUENCE { |
| cellId | PhysCellId, | |
| csi-rs-MeasurementBW | | SEQUENCE { |
| nrofPRBs | ENUMERATED { size24, size48, size96, size192, size264}, | |
| startPRB | INTEGER(0..2169) | |
| }, | | |

| | | |
|---|---|---|
| density | ENUMERATED {d1,d3} | OPTIONAL, |

-- Need R

| | |
|---|---|
| csi-rs-ResourceList-Mobility | SEQUENCE (SIZE (1..maxNrofCSI-RS-ResourcesRRM)) OF |

CSI-RS-Resource-Mobility

| } | | | |
|---|---|---|---|
| CSI-RS-Resource-Mobility ::= | | | SEQUENCE { |
| csi-RS-Index | CSI-RS-Index, | | |
| slotConfig | CHOICE { | | |
| ms4 | INTEGER (0..31), | | |
| ms5 | INTEGER (0..39), | | |
| ms10 | INTEGER (0..79), | | |
| ms20 | INTEGER (0..159), | | |
| ms40 | INTEGER (0..319) | | |
| }, | | | |
| associatedSSB | SEQUENCE { | | |
| ssb-Index | SSB-Index, | | |
| isQuasiColocated | | BOOLEAN | |
| } | | | OPTIONAL, -- Need R |
| frequencyDomainAllocation | | | CHOICE { |
| row1 | BIT STRING (SIZE (4)), | | |
| row2 | BIT STRING (SIZE (12)) | | |
| }, | | | |
| firstOFDMSymbolInTimeDomain | | | INTEGER (0..13), |
| sequenceGenerationConfig | | INTEGER (0..1023), | |
| ... | | | |
| } | | | |

| | |
|---|---|
| CSI-RS-Index ::= | INTEGER (0..maxNrofCSI-RS-ResourcesRRM−1) |

```
            TAG-CSI-RS-RESOURCECONFIGMOBILITY-STOP
            ASN1STOP
```

CSI-RS-CellMobility field descriptions
csi-rs-ResourceList-Mobility
List of CSI-RS resources for mobility. The maximum number of CSI-RS resources that can be
configured per frequency layer depends on the configuration of associatedSSB as described in
3GPP Specification such as in 3GPP TS 38.214, clause 5.1.6.1.3.
density
Frequency domain density for the 1-port CSI-RS for L3 mobility Corresponds to L1 parameter
‘Density’
nrofPRBs
Allowed size of the measurement BW in PRBs Corresponds to L1 parameter ‘CSI-RS-
measurementBW-size’
startPRB
Starting PRB index of the measurement bandwidth Corresponds to L1 parameter ‘CSI-RS-
measurement-BW-start’, For Further Study (FFS)_Value: Upper edge of value range unclear in
RAN1.
CSI-RS-ResourceConfigMobility field descriptions
csi-RS-CellList-Mobility
List of cells
refServCellIndex
Indicates the serving cell providing the timing reference for CSI-RS resources without
associatedSSB. The field may be present only if there is at least one CSI-RS resource configured
without associatedSSB. In case there is at least one CSI-RS resource configured without
associatedSSB and this field is absent, the wireless device uses the timing of the PCell. The CSI-
RS resources and the serving cell indicated by refServCellIndex for timing reference should be
located in the same band.
subcarrierSpacing
Subcarrier spacing of CSI-RS. Only the values 15, 30 or 60 kHz (<6GHz), 60 or 120 kHz
(>6GHz) are applicable.
CSI-RS-Resource-Mobility field descriptions
associatedSSB
If this field is present, the wireless device may base the timing of the CSI-RS resource indicated
in CSI-RS-Resource-Mobility on the timing of the cell indicated by the cellId in the CSI-RS-
CellMobility. In this case, the wireless device is not required to monitor that CSI-RS resource if
the wireless device cannot detect the SS/PBCH block indicated by this associatedSSB and cellId.
If this field is absent, the wireless device bases the timing of the CSI-RS resource indicated in
CSI-RS-Resource-Mobility on the timing of the serving cell indicated by refServCellIndex. In
this case, the wireless device is required to measure the CSI-RS resource even if SS/PBCH
block(s) with cellId in the CSI-RS-CellMobility are not detected.
CSI-RS resources with and without associatedSSB may be configured in accordance with the
rules in 3GPP Specification such as in 3GPP TS 38.214, clause 5.1.6.1.3.
csi-RS-Index
CSI-RS resource index associated to the CSI-RS resource to be measured (and used for
reporting).
firstOFDMSymbolInTimeDomain
Time domain allocation within a physical resource block. The field indicates the first OFDM
symbol in the PRB used for CSI-RS, as described in 3GPP such as in 3GPP TS 38.211, clause
7.4.1.5.3. Value 2 is supported only when DL-DMRS-typeA-pos equals 3.
frequencyDomainAllocation
Frequency domain allocation within a physical resource block in accordance with 3GPP
specification such as in 3GPP TS 38.211, clause 7.4.1.5.3 including table 7.4.1.5.2-1. The
number of bits that may be set to one depend on the chosen row in that table. For the choice
“other”, the row can be determined from the parameters below and from the number of bits set
to 1 in frequencyDomainAllocation.
isQuasiColocated
The CSI-RS resource is either QCL'ed not QCL'ed with the associated SSB in spatial parameters
as described in 3GPP Specification such as in 3GPP TS 38.214, clause 5.1.6.1.3.
sequenceGenerationConfig
Scrambling ID for CSI-RS as described in 3GPP Specification such as in 3GPP TS 38.211,
clause 7.4.1.5.2).
slotConfig
Indicates the CSI-RS periodicity (in milliseconds) and for each periodicity the offset (in number
of slots). When subcarrierSpacingCSI-RS is set to 15kHZ, the maximum offset values for
periodicities ms4/ms5/ms10/ms20/ms40 are 3/4/9/19/39 slots. When subcarrierSpacingCSI-RS
is set to 30kHZ, the maximum offset values for periodicities ms4/ms5/ms10/ms20/ms40 are
7/9/19/39/79 slots. When subcarrierSpacingCSI-RS is set to 60kHZ, the maximum offset values
for periodicities ms4/ms5/ms10/ms20/ms40 are 15/19/39/79/159 slots. When
subcarrierSpacingCSI-RS is set 120kHZ, the maximum offset values for periodicities
ms4/ms5/ms10/ms20/ms40 are 31/39/79/159/319 slots.

### CSI-RS-ResourceMapping

The IE CSI-RS-ResourceMapping is used to configure the resource element mapping of a CSI-RS resource in time- and frequency domain.

```
CSI-RS-ResourceMapping information element
            ASN1START
            TAG-CSI-RS-RESOURCEMAPPING-START
```

| CSI-RS-ResourceMapping ::= | | SEQUENCE { |
|---|---|---|
| frequencyDomainAllocation | | CHOICE { |
| row1 | BIT STRING (SIZE (4)), | |
| row2 | BIT STRING (SIZE (12)), | |
| row4 | BIT STRING (SIZE (3)), | |
| other | BIT STRING (SIZE (6)) | |
| }, | | |

| | |
|---|---|
| nrofPorts | ENUMERATED {p1,p2,p4,p8,p12,p16,p24,p32}, |

| | |
|---|---|
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, cdm4-FD2-TD2, cdm8-FD2- |

TD4},

| density | CHOICE { |
|---|---|
| dot5 | ENUMERATED {evenPRBs, oddPRBs}, |
| one | NULL, |
| three | NULL, |
| spare | NULL |
| }, | |
| freqBand | CSI-FrequencyOccupation, |
| ... | |
| } | |

```
            TAG-CSI-RS-RESOURCEMAPPING-STOP
            ASN1STOP
```

CSI-RS-ResourceMapping field descriptions
cdm-Type
CDM type as described in 3GPP Specification such as in 3GPP TS 38.214, clause 5.2.2.3.1).
density
Density of CSI-RS resource measured in RE/port/PRB as described in 3GPP Specification such
as in 3GPP TS 38.211, clause 7.4.1.5.3.
Values 0.5 (dot5), 1 (one) and 3 (three) are allowed for X=1, values 0.5 (dot5) and 1 (one) are
allowed for X=2, 16, 24 and 32, value 1 (one) is allowed for X=4, 8, 12.
For density = 1/2, includes 1-bit indication for RB level comb offset indicating whether odd or
even RBs are occupied by CSI-RS.
firstOFDMSymbolInTimeDomain2
Time domain allocation within a physical resource block as described in 3GPP Specification
such as in 3GPP TS 38.211, clause 7.4.1.5.3.
firstOFDMSymbolInTimeDomain
Time domain allocation within a physical resource block. The field indicates the first OFDM
symbol in the PRB used for CSI-RS as described in 3GPP Specification such as in 3GPP TS
38.211, clause 7.4.1.5.3. Value 2 is supported only when DL-DMRS-typeA-pos equals 3.
freqBand
Wideband or partial band CSI-RS, as described in 3GPP Specification such as in 3GPP TS
38.214, clause 5.2.2.3.1
frequencyDomainAllocation
Frequency domain allocation within a physical resource block in accordance with 3GPP
Specification such as 3GPP TS 38.211, clause 7.4.1.5.3. The applicable row number in table
7.4.1.5.3-1 is determined by the frequencyDomainAllocation for rows 1, 2 and 4, and for other
rows by matching the values in the column Ports, Density and CDMtype in table 7.4.1.5.3-1
with the values of nrofPorts, cdm-Type and density below and, when more than one row has the
3 values matching, by selecting the row where the column (k bar, 1 bar) in table 7.4.1.5.3-1 has
indexes for k ranging from 0 to 2*n−1 where n is the number of bits set to 1 in
frequencyDomainAllocation.
nrofPorts
Number of ports as described in 3GPP Specification such as in 3GPP TS 38.214, clause
5.2.2.3.1)

In NR RRC_CONNECTED mode, a wireless device is provided either with periodic, semi-periodic or aperiodic CSI-RS/TRS (Tracking reference signals or CSI RS for tracking) so it can measure the channel qualities, and/or track the reference signal in order to fine tune its time and frequency synchronization.

For a wireless device in RRC_IDLE/INACTIVE states, the wireless device may either gain knowledge regarding non-SSB RSs during RRC_Idle/Inactive either through learning, or being informed directly from the network node. Then the wireless device may exploit the non-SSB RSs to perform automatic gain control (AGC) on its RF receiver and Time/frequency sync. Combining this with its SSB reception can improve wireless device energy efficiency in idle modes.

Compared with SSB, the non-SSB RSs may spread much wider bandwidth, and much denser in frequency and/or time domain than SSB, where monitoring/receiving the whole non-SSB RSs in the full time/frequency range and with a full receiver configuration can negatively increase wireless device power consumption.

The above information disclosed in this Background section is only for enhancement of understanding of the background of the invention and therefore it may contain information that does not form the prior art that is already known to a person of ordinary skill in the art.

### SUMMARY

Some embodiments advantageously provide methods, systems, and apparatuses for receiving/processing a non-SSB reference signal at a wireless device that is in idle mode.

Aspects of the invention is defined by the appended claims, and embodiments thereof are defined by the dependent claims.

According to one or more embodiments, methods, mechanisms and criteria are disclosed with which a wireless device in idle mode(s) can receive/process an available non-SSB reference signal (e.g., a TRS) more power efficiently such as by one or more of:

Adapting the number of non-SSB RS and SSB symbols to be received/processed;

Adapting wireless device receiver bandwidth to receive/process the non-SSB RSs and SSB; and/or

Adapting the number of Rx branches enabled for non-SSB RSs and SSB reception and the use of multiple ports present.

For a wireless device, these methods can be implemented separately, or can be implemented in any combination.

Accordingly, one or more embodiments advantageously provide a wireless device that can operate in idle mode with mechanisms to receive/process the non-SSB and SSB reference signals in a power efficient manner.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture according to the principles in the present disclosure;

FIG. 2 is a block diagram of a portion of the network architecture according some embodiments of the present disclosure;

FIG. 3 is a flowchart of an exemplary process in a wireless device according to some embodiments of the present disclosure;

FIG. 4 is a diagram of TRS properties in the time-frequency domain according to some embodiments of the present disclosure;

FIG. 5 is diagram of an adjustment of the bandwidth by the wireless device according to some embodiments of the present disclosure;

FIG. 6 is a diagram of increased bandwidth for TRS reception according to some embodiments of the present disclosure;

FIG. 7 is a diagram of an example of a wireless device of occurrence according to some embodiments of the present disclosure; and

FIG. 8 is a diagram of a wireless receiving partial bandwidth according to some embodiments of the present disclosure.

### DETAILED DESCRIPTION

As described herein, there is thus a need for methods with which the wireless device can receive/process the non-SSB reference signal in a more power efficient approach when compared to existing approaches.

Before describing in detail exemplary embodiments, it is noted that the embodiments reside primarily in combinations of apparatus components and processing steps related to an idle mode wireless device receiving/processing a non-SSB reference signal. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device or node may involve instructing and/or causing the wireless device or node to change its configuration, e.g., at least one receiver interface setting/configuration and/or processing configuration. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which receiver configuration to implement.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

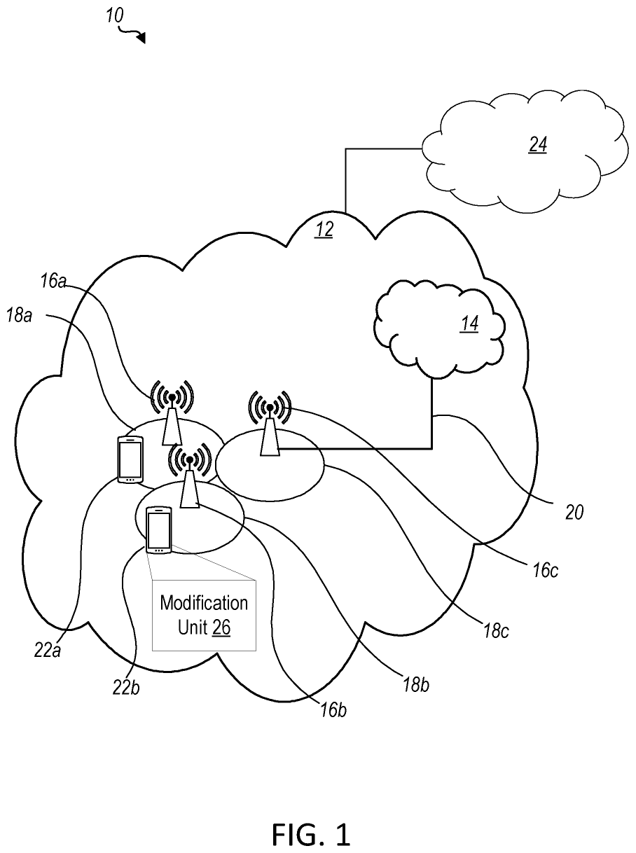

Some embodiments provide for receiving/processing a non-SSB reference signal at a wireless device that is in idle mode. Referring now to the drawing figures, in which like elements are referred to by like reference numerals, there is shown in FIG. 1 a schematic diagram of a communication syste 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN. The intermediate network 24 may be one of, or a combination of more than one of, a public, private or hosted network. The intermediate network 24, if any, may be a backbone network or the Internet. In some embodiments, the intermediate network 24 may comprise two or more sub-networks (not shown).

A wireless device 22 is configured to include a modification unit 26 which is configured to perform one or more wireless device 22 functions as described herein such as with respect to receiving/processing a non-SSB reference signal at a wireless device that is in idle mode.

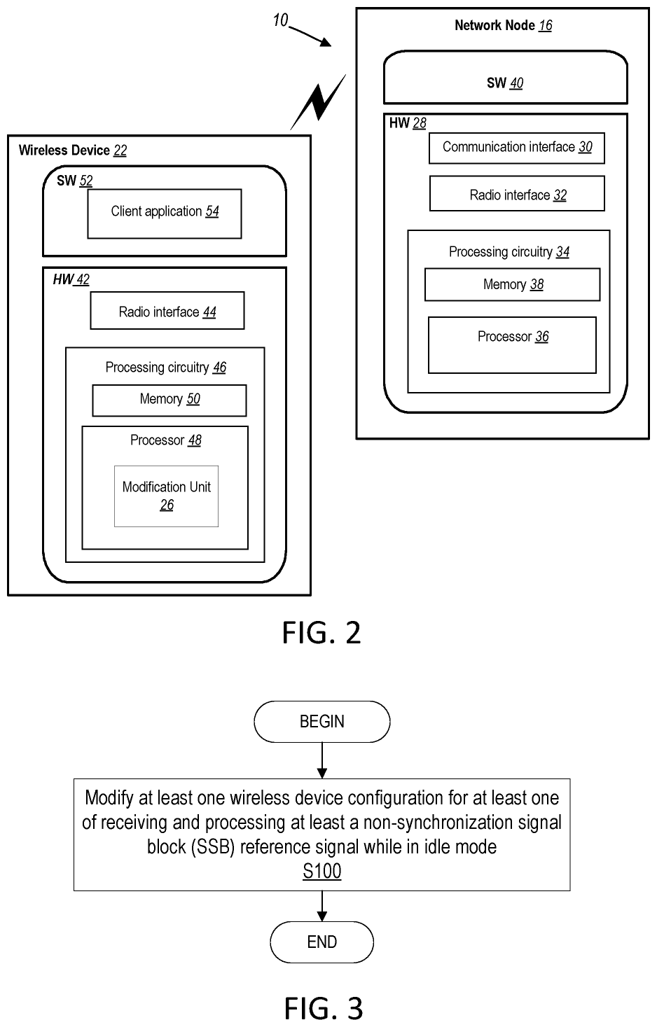

Example implementations, in accordance with an embodiment, of the WD 22 and network node 16 in the preceding paragraphs will now be described with reference to FIG. 2.

The communication system 10 further includes a network node 16 provided in a communication system 10 and including hardware 28 enabling it to communicate with WD 22 and other network nodes 16. The hardware 28 may include a communication interface 30 for setting up and maintaining a wired or wireless connection with an interface of a different communication device of the communication system as well as a radio interface 32 for setting up and maintaining at least a wireless connection with a WD 22 located in a coverage area 18 served by the network node 16. The radio interface 32 may be formed as or may include, for example, one or more RF transmitters, one or more RF receivers, and/or one or more RF transceivers.

In the embodiment shown, the hardware 28 of the network node 16 further includes processing circuitry 34. The processing circuitry 34 may include a processor 36 and a memory 38. In particular, in addition to or instead of a processor, such as a central processing unit, and memory, the processing circuitry 34 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 36 may be configured to access (e.g., write to and/or read from) the memory 38, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 40 stored internally in, for example, memory 38, or stored in external memory (e.g., database, storage array, network storage device, etc.) accessible by the network node 16 via an external connection. The software 40 may be executable by the processing circuitry 34. The processing circuitry 34 may be configured to control any of the methods and/or processes described herein and/or to cause such methods, and/or processes to be performed, e.g., by network node 16. Processor 36 corresponds to one or more processors 36 for performing network node 16 functions described herein. The memory 38 is configured to store data, programmatic software code and/or other information described herein. In some embodiments, the software 40 may include instructions that, when executed by the processor 36 and/or processing circuitry 34, causes the processor 36 and/or processing circuitry 34 to perform the processes described herein with respect to network node 16.

The communication system 10 further includes the WD 22 already referred to. The WD 22 may have hardware 42 that may include a radio interface 44 configured to set up and maintain a wireless connection with a network node 16 serving a coverage area 18 in which the WD 22 is currently located. The radio interface 44 may be formed as or may include, for example, one or more RF transmitters, one or more RF receivers (e.g., main receiver, LP receiver, etc.), and/or one or more RF transceivers where one or more of these RF entities may include and/or use one or more RF branches (e.g., antenna branches).

The hardware 42 of the WD 22 further includes processing circuitry 46. The processing circuitry 46 may include a processor 48 and memory 50. In particular, in addition to or instead of a processor, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 52, which is stored in, for example, memory 50 at the WD 22, or stored in external memory (e.g., database, storage array, network storage device, etc.) accessible by the WD 22. The software 52 may be executable by the processing circuitry 46. The software 52 may include a client application 54. The client application 54 may be operable to provide a service to a human or non-human user via the WD 22. The client application 54 may interact with the user to generate the user data that it provides.

The processing circuitry 46 may be configured to control any of the methods and/or processes described herein and/or to cause such methods, and/or processes to be performed, e.g., by WD 22. The processor 48 corresponds to one or more processors 48 for performing WD 22 functions described herein. The WD 22 includes memory 50 that is configured to store data, programmatic software code and/or other information described herein. In some embodiments, the software 52 and/or the client application 54 may include instructions that, when executed by the processor 48 and/or processing circuitry 46, causes the processor 48 and/or processing circuitry 46 to perform the processes described herein with respect to WD 22. For example, the processing circuitry 46 of the wireless device 22 may include a modification unit 26 is configured to perform one or more wireless device 22 functions as described herein such as with respect to receiving/processing a non-SSB reference signal at a wireless device that is in idle mode.

In some embodiments, the inner workings of the network node 16 and WD 22 may be as shown in FIG. 2 and independently, the surrounding network topology may be that of FIG. 1.

Although FIGS. 1 and 2 show a “unit” such as modification unit 26 as being within a respective processor, it is contemplated that this and/or other units may be implemented such that a portion of the unit is stored in a corresponding memory within the processing circuitry. In other words, the units may be implemented in hardware or in a combination of hardware and software within the processing circuitry.

FIG. 3 is a flowchart of an exemplary process in a wireless device 22 according to some embodiments of the present disclosure. One or more Blocks and/or functions performed by wireless device 22 may be performed by one or more elements of wireless device 22 such as by modification unit 26 in processing circuitry 46, processor 48, radio interface 44, etc. In one or more embodiments, wireless device such as via one or more of processing circuitry 46, processor 48, modification unit 26 and radio interface 44 is configured to modify (Block S100) at least one wireless device configuration for at least one of receiving and processing at least a non-synchronization signal block (SSB) reference signal while in idle mode, as described herein.

According to one or more embodiments, the modified at least one wireless device configuration is configured to reduce a number of non-SSB reference signal symbols that are one of received and processed, as described herein. According to one or more embodiments, the modified at least one wireless device configuration includes at least one of modifying a receiver bandwidth and modifying a number of receiver branches, as described herein. According to one or more embodiments, the processing circuitry 46 is further configured to determine to modify the at least one wireless device configuration based at least in part on a signal characteristic, as described herein.

Having generally described arrangements for an idle mode wireless device receiving/processing a non-SSB reference signal, details for these arrangements, functions and processes are provided as follows, and which may be implemented by the network node 16 and wireless device 22.

Some embodiments provide an idle mode wireless device receiving/processing a non-SSB reference signal. In RRC_Connected state, a wireless device is typically configured with a set of additional (in addition to SSB) reference symbols (RSs) used for optimal link operations, e.g., TRS or CSI-RS. Such usage refers to the provision (including configuration) of the RSs by the network node 16, the measurements and/or receiver tuning carried out by the wireless device 22 on those RSs, and conditionally (based on a separate network node 16-provided configuration) the reporting of the measurement carried out by the wireless device 22 to the network node 16 leading to a mutual understanding of the link quality. For the context of this disclosure, for a wireless device 22 in RRC_IDLE/INACTIVE state, the presence information regarding the non-SSB RSs is either explicitly provided by the network node 16 and thus guaranteed in specific T/F resources, or it has to be detected or learned by the wireless device 22 itself, such as via one or more of processing circuitry 46, processor 48, radio interface 44, modification unit 26, etc.

As used herein with respect to one or more embodiments, when referring to wireless device being in idle mode, it is meant that the wireless device 22 is in RRC_Idle or RRC_Inactive state. Additionally, for the sake of simplicity, the example embodiments described herein focus on TRS as a specific non-SSB RS. Nevertheless, the same concept and mechanisms can be readily extended to other non-SSB RSs, e.g., CSI-RS, PTRS, etc.

Compared with SSB, the non-SSB RSs may spread much wider bandwidth, and be much denser in frequency and/or time domain than SSB such that monitoring/receiving the whole non-SSB RSs in the full time/frequency range can be very costly on wireless device power consumption.

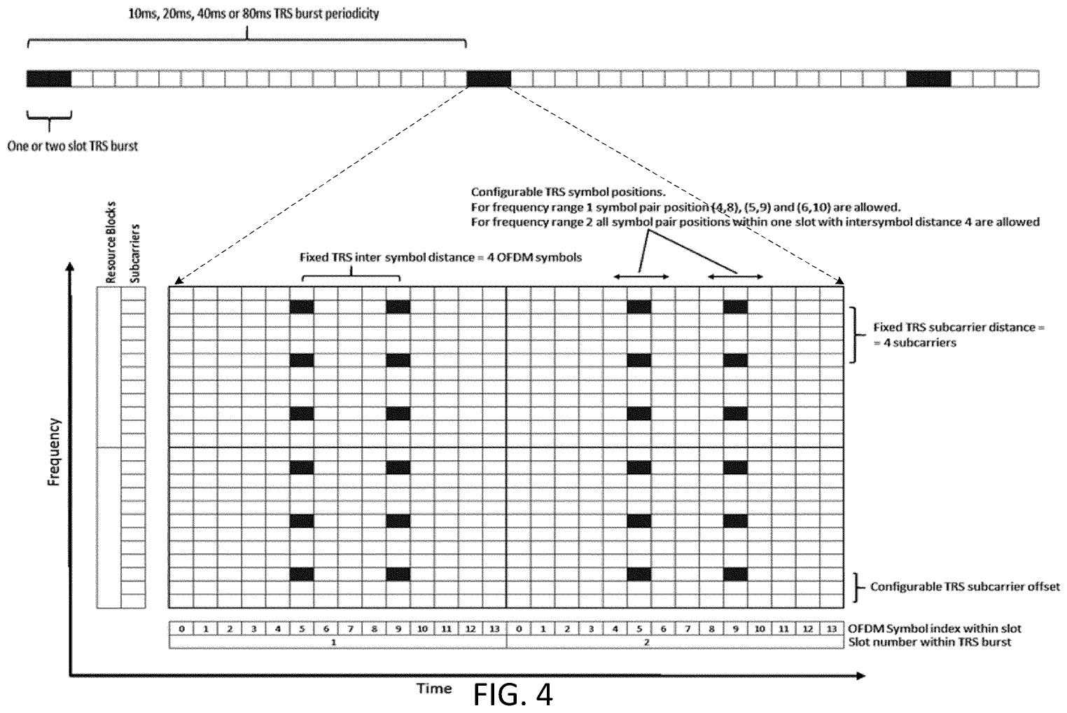

Using TRS as an example, as shown in FIG. 4, TRS comes in bursts with a periodicity of 10 ms, 20 ms, 40 ms or 80 ms. Each TRS burst consists of 1 or 2 slots. TRS is present in 2 OFDM symbols in each slot in a TRS burst. The symbol pair positions within a slot with a inter symbol distance of 4. The bandwidth of the TRS symbol is min (52 RB, wireless device BWP) or wireless device BWP. For instance, in NR with subcarrier spacing of 15 kHz, this can be from 9.36 MHz to 400 MHz. Along the frequency domain, every 4th subcarrier is used for the TRS. Four ports of TRS may be interleaved in one TRS symbol using a comb structure.

### Adaptation of Non-SSB RS Reception in Time and Frequency

In general, the narrower bandwidth of a signal that the wireless device such as via one or more of processing circuitry 46, processor 48, radio interface 44, modification unit 26, etc., receives/processes, the lower the power that the wireless device consumes. The wireless device such as via one or more of processing circuitry 46, processor 48, radio interface 44, modification unit 26, etc., may determine the appropriate bandwidth for non-SSB RS reception based on, e.g., the received signal quality. As one purpose of the non-SSB RS reception is to facilitate, e.g., Time/Frequency synchronization or signal power measurement ahead of SSB reception and/or paging PDCCH monitoring, the required number of samples may depend on the signal quality—at high signal to interference plus noise ratio (SINR), a small number of samples may be sufficient for reliable sync or power estimation. The wireless device 22 such as via one or more of processing circuitry 46, processor 48, radio interface 44, modification unit 26, etc., may thus select a lower partial bandwidth for the non-SSB RS reception at high SINR and wider bandwidth at lower SINR to obtain a higher processing gains for Noise+Interference suppression.

According to similar criteria of required Noise+Interference suppression, the wireless device 22 such as via one or more of processing circuitry 46, processor 48, radio interface 44, modification unit 26, etc., may choose/select the number of non-SSB RS symbols to receive for non-SSB RS assistance—higher signal quality may necessitate receiving fewer symbols. The Time-domain number of symbols and the Frequency-domain bandwidth selection may be performed jointly to ensure receiving a total required number of REs.

The partial bandwidth selection may also be based on the required resolution for Time-sync at a given SINR. Generally, the required bandwidth is inversely proportional to the required Time-sync accuracy, e.g., on the order of the CP length for reliability performing an ICI-free FFT, but the required bandwidth may be narrower at a high SINR.

The wireless device 22 such as via one or more of processing circuitry 46, processor 48, radio interface 44, modification unit 26, etc., may choose the partial BW also based on the ability to perform coherent accumulation in Time/Frequency domain due to time dispersion (frequency variations) and Doppler (time variations) of the signal. If the extent of coherent accumulation along a dimension is limited, the number of symbols or the bandwidth may be extended to ensure sufficient processing gain (Noise+Interference suppression) after block addition of coherently correlated signal segments.

### Use of Multiple RX Branches and Reception of Multiple Non-SSB RS Ports in Idle Mode

According to one or more embodiments, for a wireless device 22 with multiple Rx branches, more RE samples can be collected when more Rx branches being enabled such as via one or more of processing circuitry 46, processor 48, radio interface 44, modification unit 26, etc. For example, when N Rx branches are enabled, the number of RE samples can be collected such as via one or more of processing circuitry 46, processor 48, radio interface 44, modification unit 26, etc., is N times as the number of RE samples from one single Rx branch. This can greatly improve AFC stability though more active Rx branches leads to more power consumption.

The wireless device 22, such as via one or more of processing circuitry 46, processor 48, radio interface 44, modification unit 26, etc., can adapt/modify the number of its Rx branches to receive the non-SSB RSs. For example, when the signal quality of non-SSB RS is high, or multiple non-SSB symbols can be sampled, the wireless device 22 such as via one or more of processing circuitry 46, processor 48, radio interface 44, modification unit 26, etc., may enable a single Rx branch or less Rx branches than would normally be enabled. For another example, in a full configuration, TRS contains four ports of independent RS that are separated in the RE comb structure in a TRS symbol or by different sequences in same Time/Frequency resources. The ports may be individually beamformed. According to one or mor embodiments, the wireless device 22 such as via one or more of processing circuitry 46, processor 48, radio interface 44, modification unit 26, etc., may separately coherently correlate RE samples corresponding to each available RX branch/TRS port combination. Since phase alignment across ports and across RX antennas cannot be assumed, the individual coherent correlation results may not be summed coherently. In one embodiment, the wireless device 22 such as via one or more of processing circuitry 46, processor 48, radio interface 44, modification unit 26, etc., may combine the coherent correlation powers to obtain additional Noise+Interference suppression. In another embodiment, the wireless device such as via one or more of processing circuitry 46, processor 48, radio interface 44, modification unit 26, etc., may estimate the SINR of the individual coherent correlation results and may use the powers of one or more highest-SINR outputs. In a further embodiment, the wireless device 22 such as via one or more of processing circuitry 46, processor 48, radio interface 44, modification unit 26, etc., may perform SINR-weighted summing of the individual powers, or it may estimate the relative phase of the individual correlation results and their SINR and perform MRC-type coherent combining of the results.

### Reception of Non-SSB With a Low Power (LP) Receiver

The wireless device 22, such as via one or more of processing circuitry 46, processor 48, radio interface 44, modification unit 26, etc., may determine the appropriate hardware for non-SSB RS reception based at least one, for example, the reception bandwidth of the non-SSB RS, purpose of the non-SSB reception, etc. In one embodiment, wireless device 22, such as via one or more of processing circuitry 46, processor 48, radio interface 44, modification unit 26, etc., can implement a LP (e.g., low power)-receiver (i.e., part of radio interface 44) for non-SSB RSs reception. The LP-receiver can perform automatic gain control (AGC) from the received non-SSB RSs and forward the AGC value to the main receiver (i.e., part of radio interface 44). The main receiver may directly use the AGC value for coming SSB or paging PDCCH signal reception. The wireless device 22 such as via one or more of processing circuitry 46, processor 48, radio interface 44, modification unit 26, etc., may use the AGC value as an initial value for the main receiver in order to increase its AGC convergence speed.

The main receiver may also need a calibration parameter. For example, the LNA of the LP-receiver may be tuned such as via one or more of processing circuitry 46, processor 48, radio interface 44, modification unit 26, etc., to a lower amplification level of main receiver to achieve more power savings, or additional HW components in the main receiver may invoke different level of AGC. As such, a calibration may be invoked by the main receiver when using the AGC from the LP-receiver. The calibration parameter, can be a simple coefficient multiplied by the AGC of LP-receiver, or an additional constant added to the AGC of LP-receiver, or a combination of both, or other functions of AGC of LP-receiver. The calibration can be further predicted, learned or estimated based on a series of measurements and tuning between LP-receiver and main receiver.

### Usage Examples of Non-SSB RS in Idle Mode

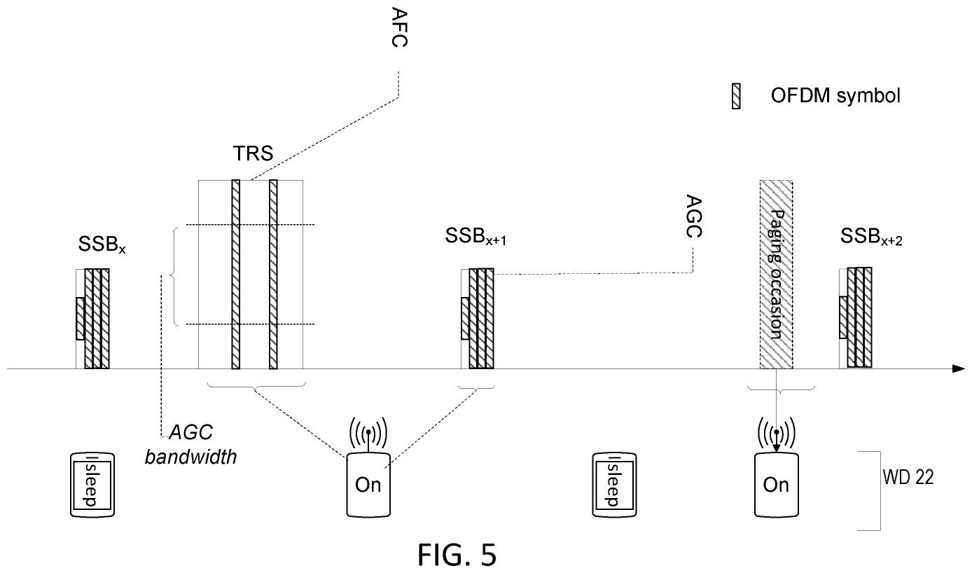

As shown in FIG. 5, the RF receiver (i.e., part of radio interface 44) in a wireless device can adjust its bandwidth, via processing circuitry 46, to receive a partial bandwidth of the TRS by configuring a narrow selectivity/antialiasing filter around the partial bandwidth segment of interest and operating the ADC at the Nyqvist rate (or moderately above) for the selected partial bandwidth. The A/D converter (i.e., party of processing circuitry 46) in the wireless device 22 thus collects only samples across the partial bandwidth. Then the AGC algorithm in the wireless device 22 can run on/use the samples from the narrow bandwidth signal. Thereafter the AGC is tuned and applied to the following SSB/paging reception.

In one embodiment, wireless device 22 such as via one or more of processing circuitry 46, processor 48, radio interface 44, modification unit 26, etc., receives a partial bandwidth of TRS RSs to tune its AGC. The partial bandwidth can be as the same bandwidth as SSB where the bandwidth is 20 RBs; or it can be more or less than SSB bandwidth but less than the full bandwidth of the TRS.

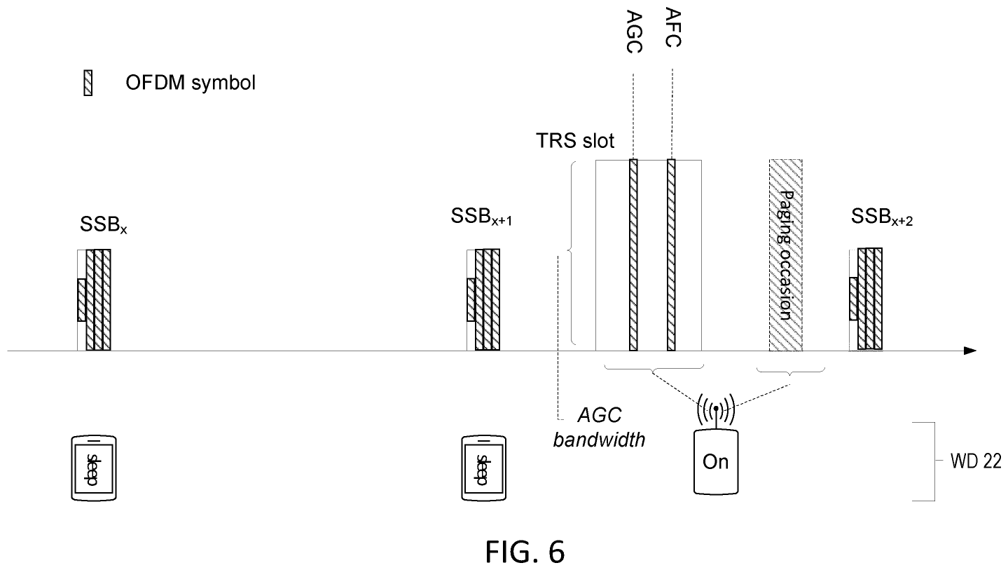

Referring to FIG. 6, in another example where TRS may be the closest to PO, wireless device 22, such as via one or more of processing circuitry 46, processor 48, radio interface 44, modification unit 26, etc., may wakeup for TRS slot and perform AGC using the 1st TRS symbol, and perform AFC using the other TRS symbol. To help ensure that there are enough RE samples for a stable AFC in one symbol, wireless device 22 such as via one or more of processing circuitry 46, processor 48, radio interface 44, modification unit 26, etc., may increase bandwidth of its receiver for the TRS reception. Therefore, wireless device 22 such as via one or more of processing circuitry 46, processor 48, radio interface 44, modification unit 26, etc., is able to have a longer sleep duration, which helps reduce power consumption.

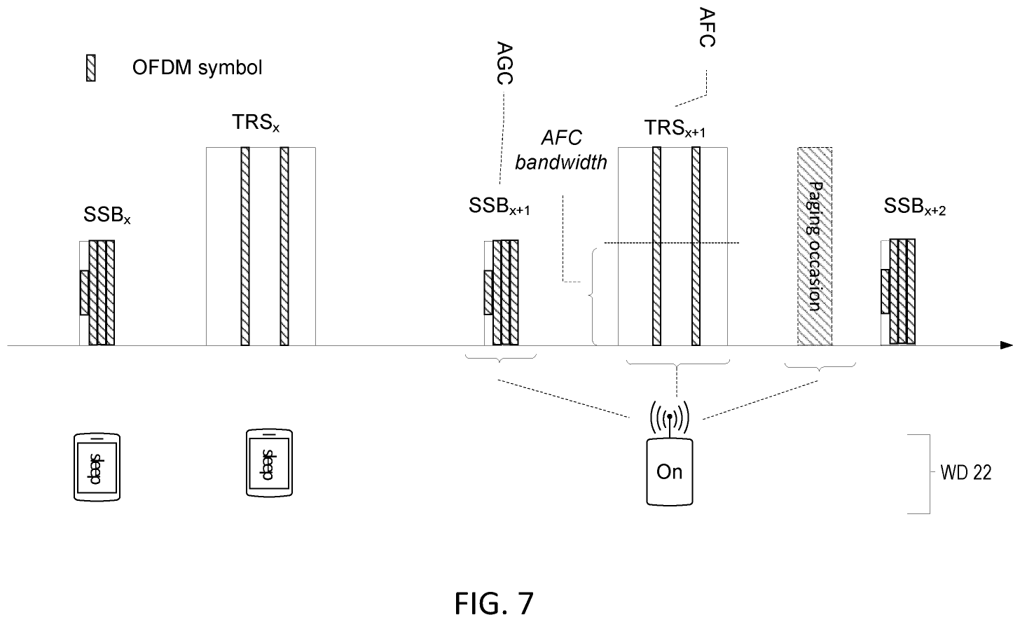

FIG. 7 is a diagram of another example where wireless device 22 such as via one or more of processing circuitry 46, processor 48, radio interface 44, modification unit 26, etc., may have an order of occurrence as SSB_x, TRS_x, SSB_x+1, TRS_x+1, PO. In this case, if the interval between SSB_x+1 and TRS_x+1 is sufficiently short to enable a consecutive AGC, AFC while the power penalty from the extra wakeup time is small. Wireless device 22 such as via one or more of processing circuitry 46, processor 48, radio interface 44, modification unit 26, etc., may wakeup for SSB_x+1 to perform AGC, and perform AFC in the following TRSx+1. Since there are 2 TRS symbols in TRSx+1 slot, wireless device 22 can reduce its reception bandwidth while still be able to collect enough RE samples in 2 symbols for stable AFC.

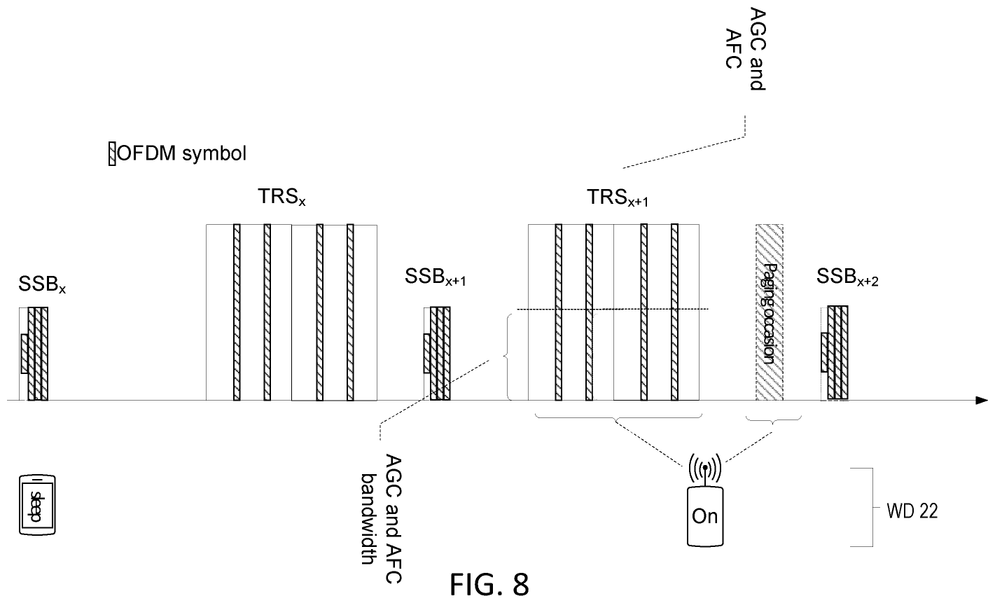

FIG. 8 is a diagram of another example where the TRS has two slots, and wireless device 22, such as via one or more of processing circuitry 46, processor 48, radio interface 44, modification unit 26, etc., may choose/determine to receive partial bandwidth of TRS along 2 slots with 4 TRS symbols. Wireless device 22, such as via one or more of processing circuitry 46, processor 48, radio interface 44, modification unit 26, etc., can perform AGC by using the 1^{st} symbol while perform AFC by using the rest 3 symbols.

Wireless device 22 such as via one or more of processing circuitry 46, processor 48, radio interface 44, modification unit 26, etc., may determine whether/how to combine the above methods, described herein, for SSB and non-SSB RS reception/processing by comparing the total wireless device 22 energy consumption of the various alternatives.

### SOME NON-LIMITING EXAMPLES

Example 1. Methods of receiving/processing non-SSB RSs, such as via one or more of processing circuitry 46, processor 48, radio interface 44, modification unit 26, etc., during RRC Idle/Inactive in wireless device 22 to improve wireless device 22 energy efficiency as compared with other arrangements.

Example 2. The methods of Example 1, wherein non-SSB RS is a TRS.

Example 3. The methods of Example 1, wherein non-SSB RS being a CSI-RS.

Example 4. The methods of any one of Examples 1-3, wherein the receiving/processing of the non-SSB RSs includes the wireless device 22 adapting its bandwidth, number of symbols to be received, and number of Rx branches to be enabled.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | 3rd Generation Partnership Project |
| 5G | 5th Generation |
| BB | Baseband |
| BW | Bandwidth |
| CDRX | Connected mode DRX (i.e. DRX in RRC_CONNECTED |
| | state) |
| CRC | Cyclic Redundancy Check |
| DCI | Downlink Control Information |
| DL | Downlink |
| DRX | Discontinuous Reception |
| gNB | A radio base station in 5G/NR. |
| HARQ | Hybrid Automatic Repeat Request |
| IoT | Internet of Things |
| LO | Local Oscillator |
| LTE | Long Term Evolution |
| MAC | Medium Access Control |
| MCS | Modulation and Coding Scheme |
| mMTC | massive MTC (referring to scenarios with ubiquitously |
| | deployed MTC devices) |
| ms | millisecond |
| MTC | Machine Type Communication |
| NB | Narrowband |
| NB-IoT | Narrowband Internet of Things |
| NR | New Radio |
| NW | Network |
| PDCCH | Physical Downlink Control Channel |
| PDSCH | Physical Downlink Shared Channel |
| RF | Radio Frequency |
| RNTI | Radio Network Temporary Identifier |
| RRC | Radio Resource Control |
| RX | Receiver/Reception |
| SSB | Synchronization Signal Block |
| T/F | Time/Frequency |
| TRS | Tracking Reference Signal |
| TX | Transmitter/Transmission |
| UE | User Equipment |
| UL | Uplink |
| WU | Wake-up |
| WUG | Wake-up Group |
| WUR | Wake-up Radio/Wake-up Receiver |
| WUS | Wake-up Signal/Wake-up Signaling |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### Example Embodiments

Embodiment A1. A wireless device (WD) configured to communicate with a network node, the WD configured to, and/or comprising a radio interface and/or processing circuitry configured to modify at least one wireless device configuration for at least one of receiving and processing at least a non-synchronization signal block (SSB) reference signal while in idle mode.

Embodiment A2. The WD of Embodiment A1, wherein the modified at least one wireless device configuration is configured to reduce a number of non-SSB reference signal symbols that are one of received and processed.

Embodiment A3. The WD of Embodiment A1, wherein the modified at least one wireless device configuration includes at least one of modifying a receiver bandwidth and modifying a number of receiver branches.

Embodiment A4. The WD of Embodiment A1, wherein the processing circuitry is further configured to determine to modify the at least one wireless device configuration based at least in part on a signal characteristic.

Embodiment B1. A method implemented in a wireless device (WD), the method comprising modifying at least one wireless device configuration for at least one of receiving and processing at least a non-synchronization signal block (SSB) reference signal while in idle mode.

Embodiment B2. The method of Embodiment B1, wherein the modified at least one wireless device configuration is configured to reduce a number of non-SSB reference signal symbols that are one of received and processed.

Embodiment B3. The method of Embodiment B1, wherein the modified at least one wireless device configuration includes at least one of modifying a receiver bandwidth and modifying a number of receiver branches.

Embodiment B4. The method of Embodiment B1, further comprising determining to modify the at least one wireless device configuration based at least in part on a signal characteristic.

1. A wireless device (WD) configured to communicate with a network node, the WD configured to, and/or comprising a radio interface and/or processing circuitry configured to modify at least one wireless device configuration for at least one of receiving and processing at least a non-synchronization signal block (SSB) reference signal while in idle mode.

2. The WD of claim 1, wherein the non-SSB reference signal is configured with wider bandwidth than a SSB reference signal bandwidth.

3. The WD of claim 1, wherein the modified at least one wireless device configuration is configured to reduce a number of non-SSB reference signal symbols that are at least one of received and processed non-SSB reference signal symbols.

4. The WD of claim 1, wherein the modified at least one wireless device configuration includes at least one of modifying a receiver bandwidth and modifying a number of receiver branches.

5. The WD of claim 1, wherein the processing circuitry is further configured to determine to modify the at least one wireless device configuration based at least in part on a signal characteristic.

6. The WD of claim 5, wherein the signal characteristic comprises signal-to-interference-and-noise ratio, SINR.

7. A method implemented in a wireless device (WD) the method comprising modifying at least one wireless device configuration for at least one of receiving and processing at least a nonsynchronization signal block, SSB, reference signal while in idle mode.

8. The method of claim 7, wherein the non-SSB reference signal is configured with wider bandwidth than a SSB reference signal bandwidth.

9. The method of claim 7, wherein the modified at least one wireless device configuration is configured to reduce a number of non-SSB reference signal symbols that are at least one of received and processed non-SSB reference signal symbols.

10. The method of claim 7, wherein the modified at least one wireless device configuration includes at least one of modifying a receiver bandwidth and modifying a number of receiver branches.

11. The method of claim 7, further comprising determining to modify the at least one wireless device configuration based at least in part on a signal characteristic.

12. The method of claim 11, wherein the signal characteristic comprises signal-to-interference-and-noise ratio, SINR.
